(19) United States
(12) Patent Application Publication
(10) Pub. No.: US 2006/0209723 A1
(43) Pub. Date: Sep. 21, 2006

(54) Network device and management technique of the same

(75) Inventor: Tetsuya Nakamura, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/374,029

(22) Filed: Mar. 14, 2006

(30) Foreign Application Priority Data
Mar. 15, 2005 (JP) 2005-073717

(51) Int. Cl. H04L 12/28

(52) U.S. Cl. 370/254

(57) ABSTRACT

When a network device, such as an ADSL modem to be connected to a communication network through an ADSL line facility, is physically connected to a port of a line facility, it is checked whether or not this connection is the first connection (or access). If this connection is the first connection, a first-time flag is affixed to data. This data is notified to the line facility, whereby the network device requests initialization setups from a management side.

### BACKGROUND OF THE INVENTION

1. Field of the Invention

The present invention relates to a network device such as an ADSL (Asymmetric Digital Subscriber Line) modem or a telephone terminal and to a management technique for its connection to a communication network. More particularly, the present invention relates to a network device that can be easily connected to a communication network, and also a management technique and network connection technique of the network device.

2. Description of the Related Art

A network device, such as an ADSL modem or a telephone terminal, requires various setups when it is connected to a communication network such as an ADSL carrier network or a FTTH (Fiber To The Home) carrier network. Doing such setups may not only require expertise in setting up network devices but also impose temporal and economic burdens on a subscriber when the subscriber connects a network device to a communication network. Therefore, there is a proposal to automatically connect a network device to a communication network (see, for example, Japanese Patent Application Unexamined Publication No. 2003-32277).

In the above-mentioned proposal, a network device, in the state of being connected to a connection device such as a hub or a router, first requests an address from a DHCP (Dynamic Host Configuration Protocol) server and is assigned an address from the DHCP server. Thereafter, the connection device monitors the timing when the network device is powered on. When the connection device detects the network device being powered on, the connection device notifies a management device of this fact. Based on this, the management device acquires the MAC (Media Access Control) address or IP (Internet Protocol) address of the network device and, when accepting a request for initialization, performs initialization of the network device.

As described above, according to the conventional proposal, the network device is connected to the connection device, and thereafter, when the network device is powered on, the connection device detects this and notifies the management device of this detection result, whereby initialization processing is started. Accordingly, when a network device is desired to be connected to a communication network, initialization will be automatically completed once the network device is connected to a connection device and then powered on.

According to such a conventional proposal, initialization of a network device is performed every time the network device is powered on. To be sure, environments in which network devices can stay connected all the time to communication networks are becoming available rapidly, and many of those network devices once initialized are continuously connected to communication networks. Therefore, in many cases, such network devices may be in a power-on state, and the number of times they are powered on/off is quite finite. Accordingly, it is generally thought that few problems are caused even if initialization is performed every time a network device is powered on.

However, in the event of a disaster or in the situation of tight power supply, a power outage occurs in a relatively wide area on occasions. Moreover, there is a trend toward reducing power consumption in view of the global environment, and there is also an effort to prevent an information processor from being hacked through a communication network. Hence, there is a move afoot to power off a network device during off-hours or sleep hours. According to the conventional network connection management, a management device repeats initialization processing every time a network device is powered on.

Therefore, it is quite conceivable that upon a recovery from a disaster or during a relatively limited time of day such as a work start hour in the morning, a very large number of network devices are powered on at a time. If network devices are powered on at the same time as stated above, a management device will congestedly perform initialization of these network devices, falling into an over-loaded state, resulting in the processing being paralyzed. To be sure, such an over-loaded state can be solved by sufficiently increasing the throughput of the management device, or by distributing the processing work among a plurality of management devices. However, such measures will increase costs needed for the management devices.

### SUMMARY OF THE INVENTION

Accordingly, an object of the present invention is to provide a network device and its management techniques, which can reduce a load imposed on its management side when a network device is initially set to be connected to a communication network.

According to an aspect of the present invention, a network device, which is connectable to a communication network by subscriber setup information, has a subscriber line termination function and is typically an ADSL modem, IP telephone terminal or the like. The network device includes: a subscriber setup information determining section for determining whether the subscriber setup information has been installed; a subscriber setup information request section for transmitting a request for the subscriber set-up information to the network device manager through a connection device when the subscriber setup information has not been installed; and a memory section for storing the subscriber setup information received from the network device manager so that the network device is connectable to the communication network.

The subscriber setup information determining section may check whether the memory stores the subscriber setup information. In this case, when the memory does not store any subscriber setup information, it is determined that the network device makes a first-time connection to the communication network.

The network device may further include a subscriber setup information setting section for setting the subscriber setup information received from the network device manager.

As described above, when a network device is connected to a communication network such as the Internet, it is determined whether or not subscriber setup information is already stored in the memory. When a network device is shipped out from a factory, the subscriber setup information, which allows the network device to be connected to the communication network, is not installed and therefore has not yet been stored in the memory. On the other hand, if the network device was once connected to the communication network, the subscriber setup information was used for that connection and therefore has been stored in the memory. Accordingly, by checking whether or not the subscriber setup information is stored, it can be determined whether or not it is the first time that the network device is connected to the communication network. When it is determined that the subscriber setup information is not stored in the memory, that is, when the network device has not yet been connected to the communication network, then the network device requests the subscriber setup information from the network device manager that manages the subscriber setup information for each of various network devices in its charge. When the subscriber setup information is sent from the network device manager in response to its request, the subscriber setup information is stored in the memory of the network device originating that request. Therefore, in the case where the network device once connected to the communication network is powered on again, for example, since the subscriber setup information has been stored in the memory, it is unnecessary, according to the present invention, to perform needless processing, such as requesting the subscriber setup information again from the network device manager. By installing the subscriber setup information on the network device, connection to the communication network becomes possible thereafter. Various well-known methods can be used to determine whether or not the physical connection is the first-time connection.

According to another aspect of the present invention, a network device manager includes: a first-time connection determining section for determining, based on information received from a connection device through a line carrier network, whether a network device is physically connected to the connection device for the first time; a subscriber setup information generating section for generating subscriber setup information for the network device when it is determined that the network device is physically connected to the connection device for the first time; and a subscriber setup information transmitting section for transmitting the subscriber setup information to the network device.

The network device manager may further includes: a memory for storing the subscriber setup information for the network device; and a subscriber setup information controller controlling such that, when having received a setup completion notification of the subscriber setup information from the network device, the subscriber setup information for the network device is deleted from the memory.

Preferably, the network device manager further includes: a timer for measuring an elapsed time from when it is determined that the network device is physically connected to the connection device for the first time; a monitor for monitoring reception of a subscriber setup information request from the network device; and a notifying section for notifying the network device of abnormality when the monitor detects no reception of the subscriber setup information request within a predetermined time period measured by the timer. Further preferably, when the monitor detects no reception of the subscriber setup information request within a predetermined time period measured by the timer, the subscriber setup information controller deletes the subscriber setup information for the network device from the memory. According to an embodiment, the monitor also monitors a setup completion notification of the subscriber setup information from the network device, wherein the subscriber setup information controller deletes the subscriber setup information for the network device from the memory when the monitor detects no reception of the setup completion notification within the predetermined time period measured by the timer.

As described above, the present invention provides technological schemes on the network device management side that manages various network devices. Based on the information sent from a connection device when a network device is physically connected to the connection device, a network device manager determines whether or not this is the first time that the network device is physically connected to the connection device. For example, when subscriber setup information, which is required when the network device is connected to the communication network, does not exist on the network device side, it is determined that the network device is physically connected to the connection device for the first time. When it is determined that the connection is the first-time one as described above, the subscriber setup information generation means generates the subscriber setup information and sends it to the network device physically connected to the connection device. Accordingly, as long as the network device was once connected to the communication network, even if the network device physically connected to the connection device is powered on again, the network device manager does not need to generate the subscriber setup information, based on the information sent from the network device. As a result, it is possible to eliminate needless processing of repeatedly generating the subscriber setup information.

A network connection method according to the present invention includes: determining whether the network device is physically connected to the connection device for the first time; transmitting a request for subscriber setup information to a network device manager through the connection device and the line carrier network when it is determined that the network device is physically connected to the connection device for the first time, wherein the subscriber setup information is needed for the network device to connect to the communication network; when receiving the subscriber setup information from the network device manager, installing it on the network device; and connecting the network device to the communication network using the subscriber setup information.

As described above, the network connection method on the network device side is defined. On the network device side, it is first determined whether or not a physical connection to a given port of a connection device is the first connection. When it is determined that the physical connection is the first one, the network device requests subscriber setup information from a network device manager. Then, when the subscriber setup information is sent from the network device manager based on the request, the network device sets this information onto itself and thus becomes able to be connected to a communication network in place of the network device manager to which the network device has been connected. In this way, connection to the communication network can be carried out automatically.

A network connection management method according to the present invention, includes: determining, based on information received from the connection device through the line carrier network, whether the network device is physically connected to the connection device for the first time; generating the subscriber setup information for the network device when it is determined that the network device is physically connected to the connection device for the first time; and transmitting the subscriber setup information to the network device.

As described above, the network connection management method on the network device manager side, is defined. On the network device manager side, when a network device is physically connected to a connection device through a transmission line, it is determined, based on the information sent upon the connection, whether or not the connection is the first connection. When it is determined that the physical connection is the first one, a network device manager generates, based on the information sent from the connection device, subscriber setup information that needs to be set on the network device side when the network device is connected to a communication network and sends this subscriber setup information to the network device in question to set up the network device. Accordingly, in the case where a network device that has been connected to a communication network temporally stops its operation due to a power outage, for example, even when the power supply is recovered, the physical connection of the network device to a connection device is not determined as the first connection. Therefore, it is possible to eliminate such needless processing that the network device manager generates the subscriber setup information for the same network device repeatedly.

As described above, according to the present invention, only when a network device, to be connected to a communication network or a network device manager through a connection device, is physically connected to the connection device for the first time, the network device manager sends subscriber setup information to the network device to allow the network device to set up itself for connection to a communication network. Therefore, it is possible to eliminate such processing that the network device manager generates the subscriber setup information for the network device every time the network device is powered on, as well as to eliminate such work of the network device manager as to send the subscriber setup information to the network device frequently. Accordingly, it is possible to reduce the load on the network device manager. Even in the case where a big earthquake occurs and those network devices belonging in a particular area are powered down at the same time, there arises no such an inconvenience that these network devices request subscriber setup information at the same time when the power comes back. The same applies when network devices are powered on at a time for other reasons as described earlier.

### BRIEF DESCRIPTION OF THE DRAWINGS

FIG. 1 is a system schematic diagram showing a fundamental configuration of a network connection system according to an embodiment of the present invention.

FIG. 2 is a block diagram showing a schematic configuration of a first subscriber line termination device according to the embodiment of the present invention.

FIG. 3 is a block diagram showing a schematic configuration of a line facility according to the embodiment of the present invention.

FIG. 4 is a block diagram showing a schematic configuration of a line carrier server according to the embodiment of the present invention.

FIG. 5 is a diagram for illustrating the entire flow of the processes for specifying a subscriber in the network connection system shown in FIG. 1.

FIG. 6 is a system schematic diagram showing a configuration of a network connection system according to a first example of the present invention.

FIG. 7 is a block diagram showing a schematic configuration of a first ADSL device in the first example.

FIG. 8 is a block diagram showing a schematic configuration of an ADSL line facility in the first example.

FIG. 9 is a block diagram showing a schematic configuration of an ADSL carrier server in the first example.

FIG. 10 is a flowchart of the processing on the first ADSL modem side for notifying a communication service setup request in the first example.

FIG. 11 is a flowchart of the processing on the ADSL line facility side when a notification of step S304 is received from the first ADSL modem in the first example.

FIG. 12 is a flowchart of the processing on the ADSL carrier server side for notifying subscriber setup information in the first example.

FIG. 13 is a flowchart of the processing relating to a subscriber identification database in the first example.

FIG. 14 is a flowchart of the processing on the subscriber line termination device side after a notification of the subscriber setup information is received in the first example.

FIG. 15 is a diagram for illustrating the entire flow of a method for specifying a subscriber in a network connection system according to the first example.

FIG. 16 is a system schematic diagram showing a configuration of a network connection system according to a second example of the present invention.

FIG. 17 is a diagram for illustrating the first half of the entire flow of a method for specifying a subscriber in the network connection system according to the second example.

FIG. 18 is a diagram for illustrating the second half of the entire flow of the method for specifying a subscriber in the network connection system according to the second example.

### DETAILED DESCRIPTION OF THE PREFERRED EMBODIMENTS

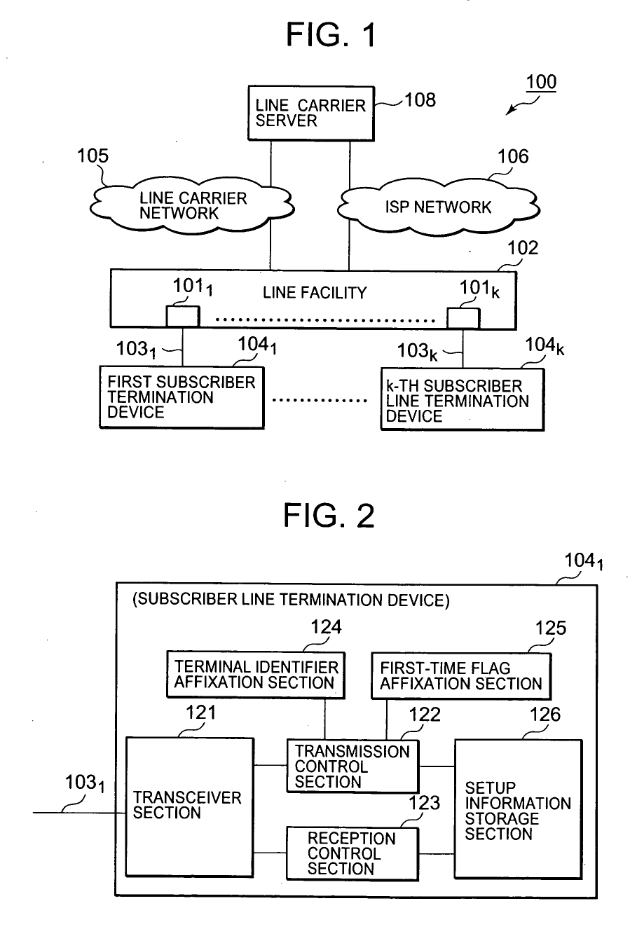

1. System FIG. 1 depicts a fundamental configuration of a network connection system according to an embodiment of the present invention. This network connection system 100 includes a line facility 102 equipped with k (k is an integer equal to or larger than one) physical ports 101₁ to 101ₖ for access line connection. First to k-th subscriber line termination devices 104₁ to 104ₖ can be connected to this line facility 102 by using access lines 103₁ to 103ₖ, respectively. The respective access lines 103₁ to ¹⁰³ₖ are provided for the subscriber's premises. The line facility 102 can be connected to a line carrier server 108 through a line carrier network 105 or an internet service provider (ISP) network 106.

1.1) Network Device

FIG. 2 depicts a schematic configuration of the first subscriber line termination device 104₁. Since the first to k-th subscriber line termination devices 104₁ to ¹⁰⁴ₖ have the same configuration, the configuration of the first subscriber line termination device 104₁ only will be described specifically here.

The first subscriber line termination device 104₁ includes a transceiver section 121 to be connected to the access line 103₁. The transceiver section 121 is configured to transmit/receive data to/from the line facility 102 (FIG. 1) through the access line 103₁ and also to perform processing involved in the transmission/reception of data, such as modulation/demodulation of data. This transceiver section 121 is connected to a transmission control section 122 for controlling data transmission and to a reception control section 123 for controlling data reception. The transmission control section 122 is connected to each of a terminal identifier affixation section 124, a first-time flag affixation section 125, and a setup information storage section 126. The reception control section 123 is connected to the setup information storage section 126. Although a program-controlled processor such as CPU is not shown in FIG. 2, operations related to the present invention may be performed under control of the CPU of the subscriber line termination device 104. The first-time flag affixation section 125 functions as a subscriber setup information determining section. The transmission control section 122, the terminal identifier affixation section 124 and the CPU (not shown) functions as a subscriber setup information request section. The setup information storage section is a memory section for storing the subscriber setup information received from the line carrier server 108. As described later, the setup information storage section is set to factory default setting such as all Os.

Here, the terminal identifier affixation section 124 is a part that, when data is transmitted by the transmission control section 122, affixes to the data a terminal identifier for allowing the first subscriber line termination device 104₁ to be identified. Examples of the terminal identifier include a MAC (Media Access Control) address assigned to each NIC (Network Interface Card), an IP address assigned to each communication network, etc.

The first-time flag affixation section 125 is a part that affixes a first-time flag to transmission data. The first-time flag is used to manage a communication service setup request when the first subscriber line termination device 104₁, is connected for the first time to the line carrier server 108 (see FIG. 1) through the access line 103₁. According to the embodiment of the present invention, only when a subscriber line termination device, which is one of the 1st to k-th subscriber line termination devices 104₁ to 104ₖ, gains access to the line carrier server 108 for the first time, the first-time flag is affixed to data transmitted from the subscriber line termination device to the line facility 102. As described later, the first-time flag is attached only when a first-time physical connection to the line facility 102 is made. Therefore a database created on the line carrier server side can be kept at the minimum. The database will be described later.

Therefore, taking the first subscriber line termination device 104₁ as an example, the first-time flag is not always set on every time the first subscriber line termination device 104₁ is powered on. According to the conventional technology, as described earlier, a setup request for connection to a communication network is made depending on the powering on/off of a network device (subscriber line termination device). In such a conventional network connection system, it is conceivable that, for example, if a power outage occurred in a relatively wide-ranging area, a large number of setup requests from the subscriber line termination devices 104 could arrive at the line carrier server 108 at the same time. Consequently, on the line carrier server side, the problem would arise that the processing becomes congested and paralyzed. The use of the first-time flag affixation section 125 can prevent such a problem from occurring. Examples of the first-time flag include control bits specially allocated to the physical layer, a VLAN (Virtual Local Area Network) tag, etc.

The setup information storage section 126 is a part that stores subscriber setup information. Incidentally, the first subscriber line termination device 104₁ is provided with a CPU (not shown) and a recording medium (not shown) storing a control program. Part of this recording medium constitutes the setup information storage section 126. Additionally, all, or some, of the above-described sections excluding the setup information storage section 126 are implemented by software, in such manner that the CPU executes the control program.

1.2) Connection Device

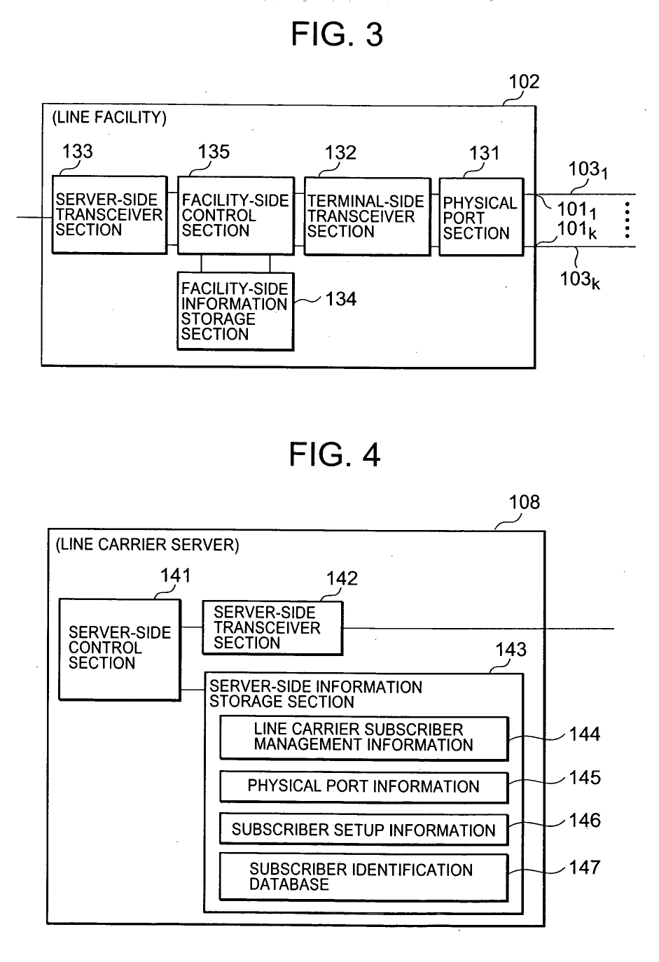

FIG. 3 depicts a schematic configuration of the line facility 102. The line facility 102 includes a physical port section 131, a terminal-side transceiver section 132 connected to the physical port section 131, a server-side transceiver section 133 connected to the line carrier network 105 and ISP network 106, a facility-side information storage section 134, and a facility-side control section 135 connected to each of the terminal-side transceiver section 132, server-side transceiver section 133, and facility-side information storage section 134. The physical port section 131 can be individually connected to the 1st to k-th subscriber line termination devices 104₁ to ¹⁰⁴ₖ through the access lines 103₁ to 103ₖ as shown in FIG. 1.

Here, the physical port section 131 includes k physical ports 101₁ to 101ₖ. An arbitrary number (here, k) of the access lines 103₁ to 103ₖ, one ends of which are respectively connected to different ones of the subscriber line termination devices 104₁ to 104ₖ, are connected or can be connected to the physical ports 101₁ to 101ₖ. A physical port number for distinguishing a corresponding port from the other ports is assigned to each of the physical ports 101₁ to 101ₖ. The facility-side information storage section 134 stores information indicating the correspondences between the physical ports and the physical port numbers and also connection information regarding the line facility 102. The connection information regarding the line facility 102 includes, for example, the installation location of the line facility, line facility number, management IP address, physical port number, etc.

The terminal-side transceiver section 132 transmits/receives data through the access lines 103₁ to 103ₖ connected to the physical ports 101₁ to 101ₖ of the physical port section 131. The terminal-side transceiver section 132 also performs, as a first-time connection determining section, processing of identifying a terminal identifier and first-time flag received from any of the 1st to k-th subscriber line termination devices 104₁ to 104ₖ. Moreover, as general processing, the terminal-side transceiver section 132 performs modulation/demodulation of data and the like. In addition, the terminal-side transceiver section 132 is also configured to extract control bits from data and to add/remove a VLAN tag.

The server-side transceiver section 133 is configured to transmit/receive data through the line carrier network 105 or ISP network 106 shown in FIG. 1. For example, the server-side transceiver section 133 performs processing of transmitting/receiving packet data on Ethernet™.

The facility-side control section 135 is provided with a CPU (not shown) and a recording medium (not shown) for temporally storing a control program to be executed by the CPU and data required when the control program is executed. The facility-side control section 135 is configured to control the entire line facility 102.

The line facility 102 having such a configuration is managed by, for example, a line carrier and functions as a connection device or a relay device which connects each of the access lines 103 to the line carrier network 105 or ISP network 106. When receiving a first-time flag, as a communication service setup request, from any one of the first to k-th subscriber line termination devices 104₁ to 104ₖ, the line facility 102 notifies the line carrier server 108 of the physical port number at which the communication service setup request is inputted, of the terminal identifier of the source subscriber line termination device, which is contained in the communication service setup request, and of the information regarding the line facility 102.

1.3) Management device FIG. 4 depicts a schematic configuration of the line carrier server 108. The line carrier server 108 is managed by the line carrier. The line carrier server 108 is a network device manager which provides subscribers with the use of the access lines 103₁ to 103ₖ shown in FIG. 1. The line carrier server 108 includes a server-side control section 141, a server-side transceiver section 142, and a server-side information storage section 143. The line carrier server 108 is configured to permit application connections from the subscriber line termination devices 104₁ to 104ₖ, based on the under-mentioned database. The application connection, as described already, means an http (HyperText Transfer Protocol) connection, https (Secure HTTP) connection or the like and includes server and client authentication and BASIC Authentication used when access control is performed by using an ID and a password. The line carrier server 108 having such a configuration can be made of, for example, a high-end personal computer such as a workstation constituting a web server.

Here, the server-side control section 141 is connected to each of the server-side transceiver section 142 and the server-side information storage section 143 and is configured to control the entire line carrier server 108 including these sections. The server-side control section 141 thus configured is provided with, for example, a CPU (not shown) and a recording medium (not shown) for temporally storing a control program to be executed by the CPU and data required when the control program is executed.

The server-side transceiver section 142 is configured to transmit/receive data through the line carrier network 105 or ISP network 106. For example, the server-side transceiver section 142 performs processing of transmitting/receiving packet data on Ethernet™. The server-side information storage section 143 stores line carrier subscriber management information 144, physical port information 145, subscriber setup information 146, and a subscriber identification database 147.

Here, the line carrier subscriber management information 144 is information regarding subscribers of the line carrier, which includes pieces of personal information, on each subscriber such as, for example, the name, address, and telephone number. The physical port information 145 is information regarding the physical ports of the line facility 102 to which the access lines 103₁ to 103ₖ are individually connected as shown in FIG. 1. For example, the physical port information 145 includes the installation location of the line facility 102, line facility number, management IP address, and physical port number.

The subscriber setup information 146 is authentication information for allowing, for example, the first subscriber line termination device 104₁ to be connected to the ISP network 106 and to obtain communication services. The subscriber setup information 146 includes an ID and/or a password for PPPoE (Point-to-Point Protocol over Ethernet™), or an ID and/or a password for using IP telephone services.

The subscriber identification database 147 is configured to temporally store respective terminal identifiers of the subscriber line termination devices 104₁ to 104ₖ, the physical port numbers of physical ports to which these devices are connected, which are notified by the line facility 102, and further information associated by the server-side control section 141 with the line carrier subscriber management information 144, physical port information 145, and subscriber setup information 146.

As described later, when receiving physical port information and terminal identifier from the line facility 102, an entry for the subscriber line termination device 104 originating the first-time flag is created in the subscriber identification database 147.

In the line carrier server 108 as described above, when an application connection is made by, for example, the first subscriber line termination device 104₁, the server-side control section 141 searches the subscriber identification database 147 for the subscriber who corresponds with the notified terminal identifier of the first subscriber line termination device 104₁. Then, the server-side control section 141 performs processing of notifying the first subscriber line termination device 104₁ of the corresponding subscriber setup information. The line facility 102 may be considered as a communication network through which an ISP provides connection services to subscribers. In the embodiment of the present invention, it can be assumed that such a communication network is, for example, the Internet. Needless to say, the type of communication network does not particularly matter as long as it is a network requiring the subscriber setup information 146 to be set.

2. System Operations

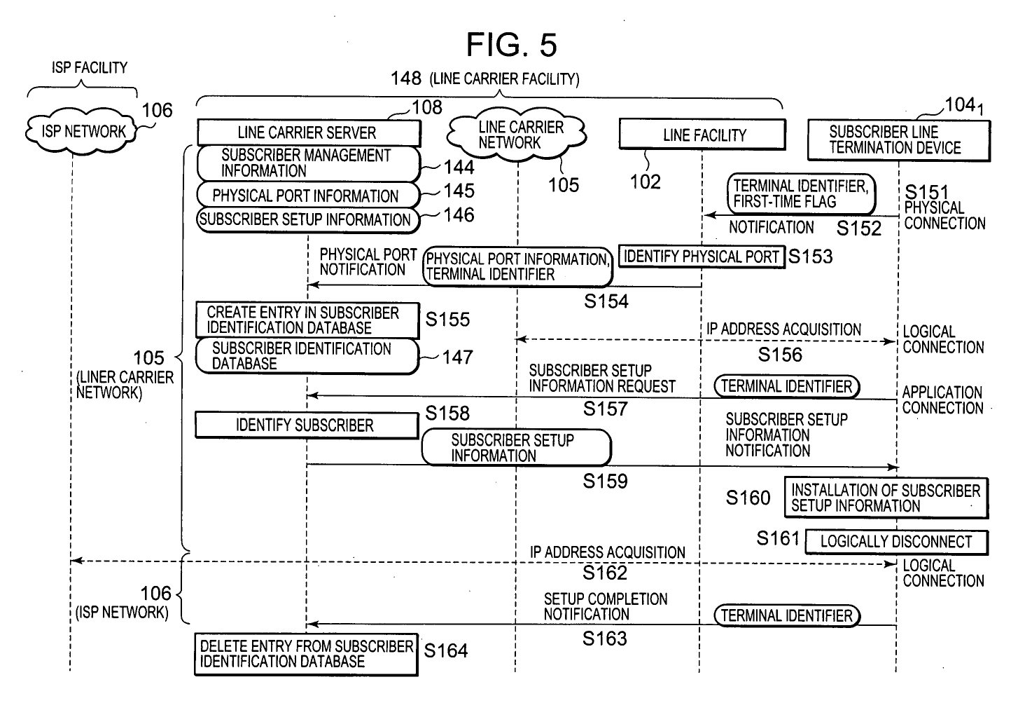

FIG. 5 shows the entire flow of a method for identifying and setting a subscriber in such a network connection system as described above. Here, a description will be given on the assumption that the first subscriber line termination device 104₁ makes a communication service setup request.

In the subscriber's premises (not shown) where the first subscriber line termination device 104₁ is installed, when the first subscriber line termination device 104₁ is physically connected to the physical port 101₁ of the line facility 102 through the access line 103₁ (step S151), the terminal identifier and first-time flag are notified to the line facility 102 which is one of the constituent portions of a line carrier facility 148 (step S152). Here, the line carrier facility 140 includes the line facility 102, line carrier network 105, and line carrier server 108.

Upon the receipt of the first-time flag, the line facility 102 identifies the physical port though which the first-time flag has been received (step S153) and notifies the line carrier server 108, through the line carrier network 105, of the terminal identifier and the physical port information indicating the physical port in question (step S154).

The line carrier server 108 compares the physical port information notified from the line facility 102 at step S154 with the physical port information 145 that is used to manage those subscribers accommodated in the line facility 102 based on the line carrier subscriber management information 144. The line carrier server 108 then identifies the subscriber using the first subscriber line termination device 104₁ and makes an entry for the identified subscriber in the subscriber identification database 147, wherein the entry is composed of the terminal identifier and the subscriber setup information 146 (step S155).

At this stage, the first subscriber line termination device 104₁ acquires an IP address of its own through a logical connection (step S156). The first subscriber line termination device 104₁ then notifies the line carrier server 108 of its own terminal identifier as a request for subscriber setup information (step S157).

Using the notified terminal identifier of the first subscriber line termination device 104₁, the line carrier server 108 searches the subscriber identification database 147 to identify the subscriber in question (step S158). The line carrier server 108 then extracts the subscriber setup information 146 for the subscriber corresponding to the terminal identifier and notifies the first subscriber line termination device 104₁ of the extracted subscriber setup information 146 (step S159).

The first subscriber line termination device 104₁ performs installation of the notified subscriber setup information 146. That is, the first subscriber line termination device 104₁ stores the subscriber setup information in executable form in the setup information storage section 126 (step S160). Thereafter, the first subscriber line termination device 104₁ is logically disconnected (step S161) and then uses the information regarding the set-up service to be logically connected to the ISP network (Internet) 106 (step S162). The first subscriber line termination device 104₁ notifies the line carrier server 108, through the ISP network 106, of its own terminal identifier as a setup completion notification (step S163). Upon this notification, the line carrier server 108 deletes the corresponding entry from the subscriber identification database 147 (step S164).

Hereinafter, the present invention will be described in more detail based on specific examples.

### EXAMPLE I

A description will be given of a first example that is a more concrete form of the network connection system 100 shown in FIG. 1. In the first example, a subscriber is identified in an ADSL network connection system.

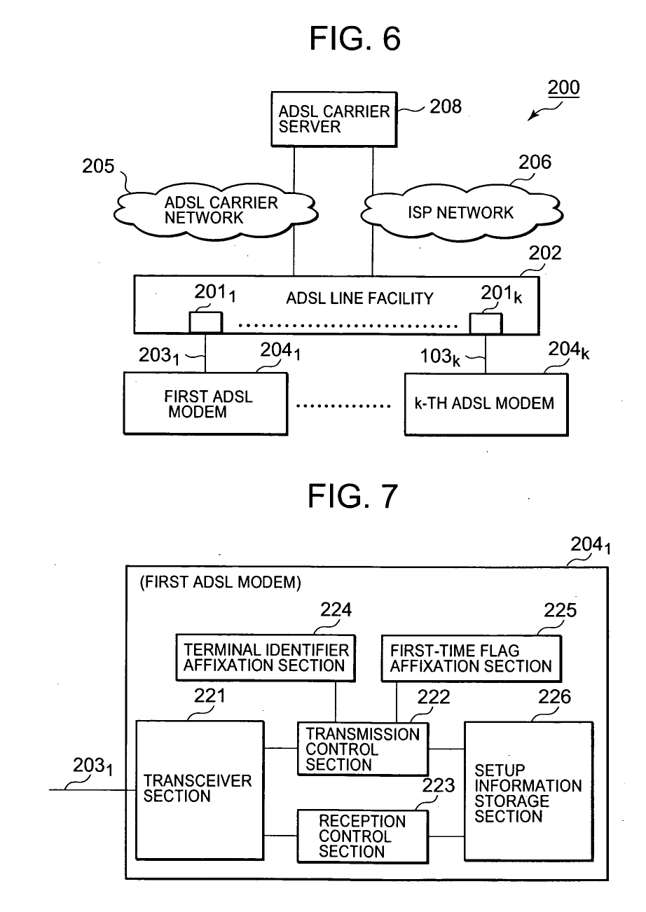

FIG. 6 corresponds to FIG. 1 and depicts a configuration of a network connection system using ADSL (Asymmetric Digital Subscriber Line) lines according to the first example. The ADSL-based network connection system 200 includes an ADSL line facility 202 equipped with k (k is an integer equal to or larger than two) physical ports 201₁ to 201ₖ for access line connection. First to k-th ADSL modems 204₁ to 204ₖ, as the 1st to k-th subscriber line termination devices, can be connected to the ADSL line facility 202 by using access lines 203₁ to 203ₖ, respectively. Moreover, the ADSL line facility 202 can be connected to an ADSL carrier server 208 through an ADSL carrier network 205 or ISP network 206.

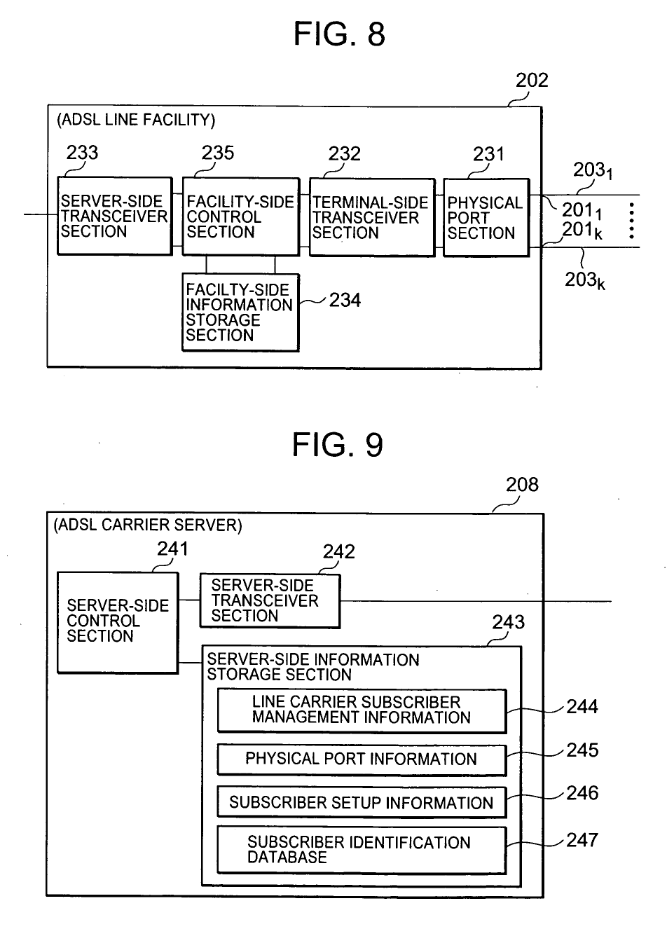

FIG. 7 corresponds to FIG. 2 and depicts a schematic configuration of the first ADSL modem 204₁. FIG. 8 corresponds to FIG. 3 and depicts a schematic configuration of the ADSL line facility 202. Further, FIG. 9 corresponds to FIG. 4 and depicts a schematic configuration of the ADSL carrier server 208. Note that in FIGS. 7 to 9, the parts corresponding to those in FIGS. 2 to 4 are denoted by the same reference numerals each plus 100, and a description thereof will be omitted. Furthermore, in the first example, a description will be given on the assumption that the first ADSL modem 204₁ makes a communication service setup request.

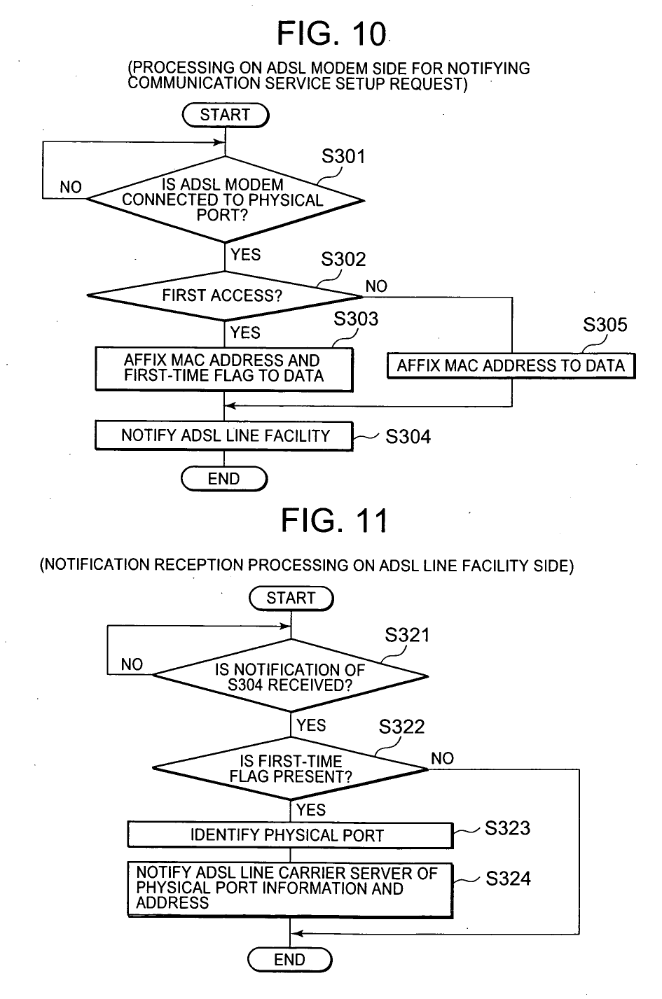

FIG. 10 shows a flow of the processing on the first ADSL modem side for notifying the communication service setup request in the first example, which will now be described in conjunction with FIGS. 7 to 9. The CPU (not shown) of the first ADSL modem 204₁ waits to be physically connected to any one of the physical ports 201₁ to 201ₖ (FIG. 8) of the ADSL line facility 202 through the access line 203₁ (step S301). For example, when the first ADSL modem 204₁ is physically connected to the physical port 201₁ of the ADSL line facility 202 (Y at step S301), the transmission control section 222 determines whether or not this is the first access (first physical connection) to the ADSL carrier server 208 (step S302).

In the first example, the determination as to “whether or not this is the first access” is performed as follows. In the first ADSL modem 204₁, the setup information storage section 226 shown in FIG. 7 is set for a given control bit string (e.g., a control bit string composed of blanks, all “0s”) when the first ADSL modem 204₁ is shipped out from a factory. Every time the first ADSL modem 204₁ is connected to the ADSL line facility 202, the first-time flag affixation section 225 of the first ADSL modem 204₁ reads the content of this set value storage field and notifies it to the connection destination, that is, the ADSL line facility 202. Therefore, when the first ADSL modem 204₁ is connected to the ADSL line facility 202 for the first time, the “first-time flag,” composed of the control bit string as the blank data in the setup information storage section 226, is transmitted. Thereafter, once subscriber setup information is stored in (written over) the setup information storage section 226, the subscriber setup information will be read from then on, and therefore the “first-time flag” will no longer be transmitted.

It is also possible that a control section in the first ADSL modem 204₁, such as the first-time flag affixation section 225 or transmission control section 222, monitors the setup information storage section 226, and sets the first-time flag off before the subscriber setup information is stored and sets the first-time flag on after the subscriber setup information is stored. In this case, the timing when the subscriber setup information is stored is monitored in the state where the first ADSL modem 204₁ is powered on and also where the first-time flag is off. After the first-time flag is set on, the monitoring as to when the subscriber setup information is stored will be no longer performed even when the first ADSL modem 204₁ is powered on.

In the case where an ADSL modem 204₁ such as the pre-owned first ADSL modem 204₁, is transferred to another user, the subscriber setup information has been set on the ADSL modem 204. Therefore, if the another user connects this ADSL modem 204 to the ADSL line facility 202 in a communication environment different from the previous connection environment, the subscriber setup information will be inappropriate and the ADSL modem 204 cannot be connected to the ISP network 206. In this case, it suffices that the ADSL modem 204 is returned to the state at the time of shipment from a factory. By doing so, a subsequent physical connection of the ADSL modem 204 to the ADSL line facility 202 is made the first connection. This differs from the concept of resetting the subscriber setup information every time a network device, such as the ADSL modem 204₁ is powered on.

Referring again to FIG. 10, at step S302, in the case of a determination that this is the first access to the ADSL carrier server 208 (Y), the MAC address of the first ADSL modem 204₁, as the terminal identifier, and the first-time flag are affixed to data by the terminal identifier affixation section 224 and first-time flag affixation section 225, respectively, when transmission of the data responding to the determination is started (step S303). The MAC address and first-time flag are notified to the ADSL line facility 202 (step S304). In other words, when the first ADSL modem 204₁ makes a physical connection at the subscriber's premises, the MAC address, which is uniquely owned by the first ADSL modem 204₁, and the first-time flag, which is a control bit string on the ADSL layer for requesting subscriber setup information, are notified to the ADSL line facility 202 by using a control bit string or control bit on the physical layer (step S304). With this notification, the processing for notifying the communication service setup request is completed (END).

On the other hand, at step S302, in the case of a determination that this is not the first access to the ADSL carrier server 208 (N), the transmission control section 222 extracts the MAC address of the first ADSL modem 204₁, as the terminal identifier, from the terminal identifier affixation section 224 (step S305). Affixation of the first-time flag by the first-time flag affixation section 225 is not performed. This MAC address only is notified to the ADSL line facility 202 (step S304).

FIG. 11 shows a flow of the processing on the ADSL line facility side when the notification of step S304 is received from an ADSL modem such as the first ADSL modem 204₁. When the ADSL line facility 202 receives the notification of step S304 (Y at step S321), the control section 235 of the ADSL line facility 202 checks whether or not the first-time flag is present in this notification (step S322). If the first-time flag is not present (N at step S322), communication service setup has been already performed, and therefore the processing is completed (END).

On the other hand, when the first-time flag is present in the notification of step S304 (Y at step S322), the ADSL line facility 202 identifies the physical port to which the first ADSL modem 204₁ is connected through the access line 203₁ (step S323). Then, the ADSL line facility 202 notifies the ADSL carrier server 208, through the ADSL carrier network 205, of the physical port information indicating the physical port in question and the MAC address as the terminal identifier (step S324). The processing is then completed (END).

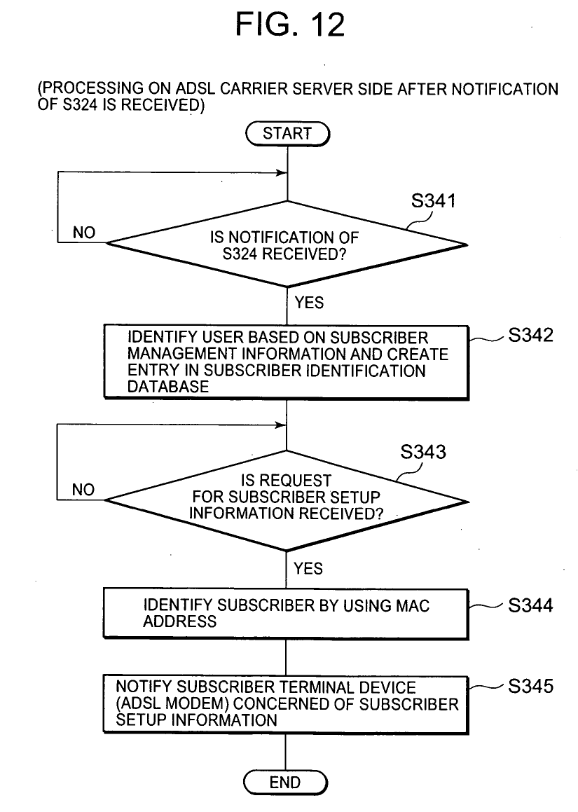

FIG. 12 shows a flow of the processing on the ADSL carrier server side after the notification of step S324 is received. When the ADSL carrier server 208 receives the notification of step S324 through the ADSL carrier network 205 (Y at step S341), the control section 241 of the ADSL carrier server 208 compares the physical port information notified from the ADSL line facility 202 at step S324 with the physical port information 245 that is used to manage subscribers accommodated in the ADSL line facility 202 based on the line service provider subscriber management information 244 (FIG. 11). Thus, the ADSL carrier server 208 identifies the subscriber using the first ADSL modem 204₁ and creates an entry in the subscriber identification database 247, which is composed of the MAC address and the subscriber setup information 246 (step S342). Meanwhile, the first ADSL modem 204₁ acquires a PPPoE ID and password from the ADSL carrier network 205 and makes a PPPOE connection to the ADSL carrier network 205. Based on this connection, the first ADSL modem 204₁ transmits its own MAC address to the ADSL carrier server 208 and thereby requests the subscriber setup information.

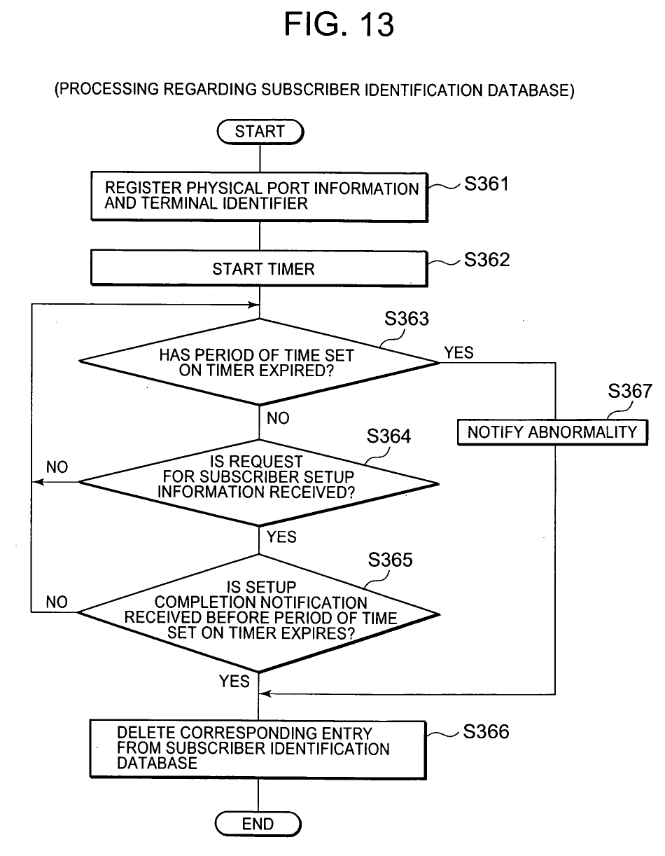

FIG. 13 shows a flow of the processing related to the subscriber identification database on the ADSL carrier server side after the subscriber identification database is created. Under control of the control section 241, the ADSL carrier server 208 registers the physical port information 245 and the MAC address as the terminal identifier (step S361). Then, a timer is started (step S362). It is monitored whether or not a request for the subscriber setup information, by means of an application connection, arrives from the first ADSL modem 204₁ (step S364) before a period of time set on the timer has expired (N at step S363). The application connection is as described earlier.

If the request for the subscriber setup information, by means of an application connection, arrives from the first ADSL modem 204₁ before the period of time set on the timer has expired (Y at step S364), it is further checked whether or not a setup completion notification arrives before the period of time set on the timer has expired (step S365). This checking is performed because, when the request for the subscriber setup information arrives from the first ADSL modem 204₁ at step S364, the subscriber is identified and the subscriber setup information 246 for the subscriber in question is notified to the first ADSL modem 204₁, and therefore, based on this, the first ADSL modem 204₁ sends the setup completion notification to the ADSL carrier server 208. When the setup completion notification is sent as described above before the period of time set on the timer has expired (Y at step S365), then a corresponding entry is deleted from the subscriber identification database 247 (step S366).

On the other hand, in some cases, the period of time set on the timer expires (Y at step S363) before the request for the subscriber setup information arrives from the first ADSL modem 204₁ (N at step S364), or before the setup completion notification is received (N at step S365). In this case, on the supposition that some abnormality has occurred, an abnormality notification is made to the first ADSL modem 204₁ (step S367), in which case a corresponding entry is deleted from (step S366).

Returning to FIG. 12, when the ADSL carrier server 208 has created an entry for the subscriber in the subscriber identification database 247 at step S342, the ADSL carrier server 208 waits until the request for the subscriber setup information arrives from the first ADSL modem 204₁ (step S343; see step S364 in FIG. 13). When the request for the subscriber setup information arrives, the ADSL carrier server 208 identifies the subscriber using the first ADSL modem 204₁, based on the MAC address as the terminal identifier of the first ADSL modem 204₁, which has been affixed to the arriving request (step S344). Then, the ADSL carrier server 208 notifies the first ADSL modem 204₁, as the subscriber line termination device of the identified subscriber, of the subscriber setup information 246 (step S345). This subscriber setup information 246 contains an ID and a password for PPPoE connection to the ISP network 206 (see FIG. 6). In this way, the processing for notifying the first ADSL modem 204₁ of the subscriber setup information is completed (END). Thus, a PPPoE connection is enabled between the first ADSL modem 204₁ and the ADSL carrier network 205.

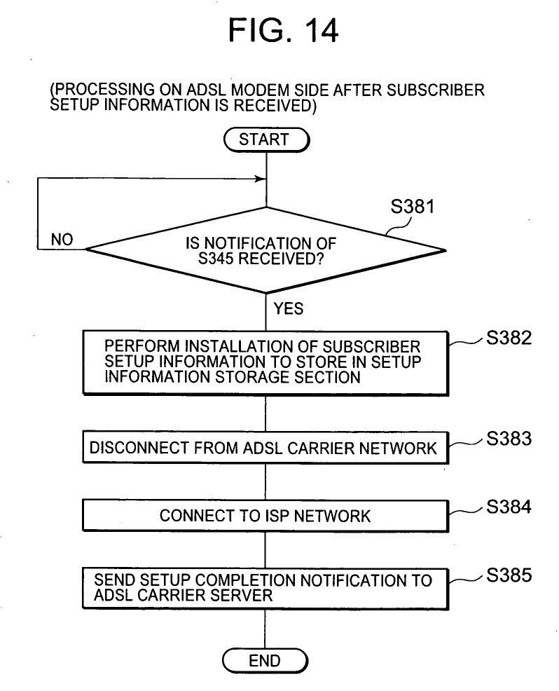

FIG. 14 shows the processing on the subscriber line termination device (ADSL modem) side after the notification of the subscriber setup information of step S345 in FIG. 12 is received. When the first ADSL modem 204₁ receives the notification of the subscriber setup information 246 of step S345 (Y at step S381), the first ADSL modem 204₁ performs installation of this subscriber setup information 246 to store it in the setup information storage section 226 shown in FIG. 7 and thereby brings the subscriber setup information 246 into being executable by the first ADSL modem 204₁ (step S382). Thereafter, the first ADSL modem 204₁ is logically disconnected from the ADSL carrier network 205 (step S383) and is connected instead to the ISP network 206 (see FIG. 6) (step S384). In this event, the first ADSL modem 204₁ uses the ID and password for PPPoE connection, to make a PPPoE connection (logical connection) to the ISP network 206. Then, the first ADSL modem 204₁ sends the setup completion notification to the ADSL carrier server 208, as an application connection (step S385). Upon this notification, as described above, the ADSL carrier server 208 deletes the corresponding entry from the subscriber identification database 247 by using the MAC address as a key, sent from the first ADSL modem 204₁ as the terminal identifier along with the notification (see step S366).

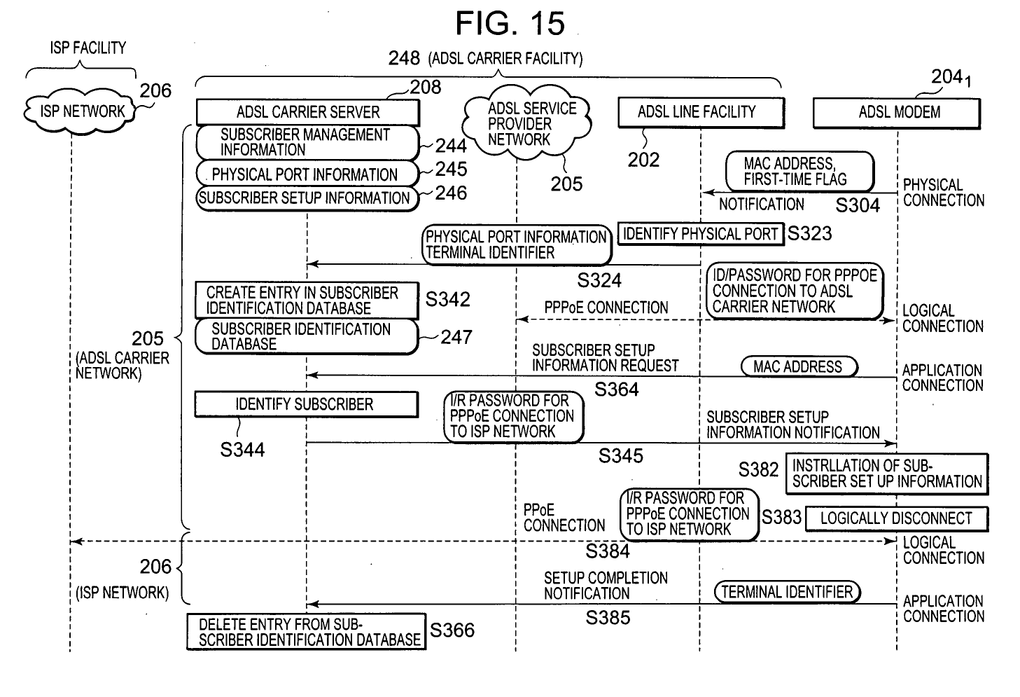

FIG. 15 corresponds to FIG. 5 and shows the entire flow of a method for identifying a subscriber in the network connection system according to the first example. Note that a description of FIG. 15 overlaps with the above description and therefore will be omitted, and that the reference numerals to the steps and components are applied in FIG. 15 as appropriate. Additionally, in FIG. 15, an ADSL service provider facility 248 includes the ADSL line facility 202, the ADSL carrier network 205, and the ADSL carrier server 208.

According to the above-described first example, the following advantages can be achieved.

(1) First, according to the first example, a subscriber is identified on the side of a line carrier facility, resulting in an advantage that the information used to identify the subscriber can be kept secret without being given to the subscriber side.

(2) Moreover, according to the first example, a physical line is identified based on a terminal identifier uniquely owned by a subscriber line termination device such as an ADSL modem, and a subscriber is identified by using this unique information as a key. This brings an advantage that a subscriber can be identified without a need for a line carrier to manage in advance the terminal identifiers unique to devices, such as MAC addresses.

(3) Further, according to the first example, time management as to when a physical port is identified is performed at the subscriber identification database 247. Therefore, even if a terminal identifier, which is uniquely owned by a subscriber line termination device such as an ADSL modem, is faked, the information unique to a device must be notified within a given period of time after a physical connection is made. As a result, it can be made difficult to gain unauthorized access in the disguise of a subscriber.

(4) Furthermore, according to the first example, when the ADSL line facility 202 is notified of a setup request flag, which is made effective only at the time of setting up an ADSL modem, the ADSL carrier server 208 creates a corresponding entry in the subscriber identification database 247 only using the information on a subscriber for which the setup request flag is present. Accordingly, it can be made easier to perform a search, on the information limited to those ADSL modems 204 which have made a request for subscriber setup information.

(5) Lastly, according to the first example, a subscriber can be identified based on a physical port to which an ADSL modem is connected, regardless of the logical configuration of a line facility. Accordingly, as a fifth advantage, the logical configuration inside the ADSL line facility 202 does not affect the network connection system 200.

### EXAMPLE II

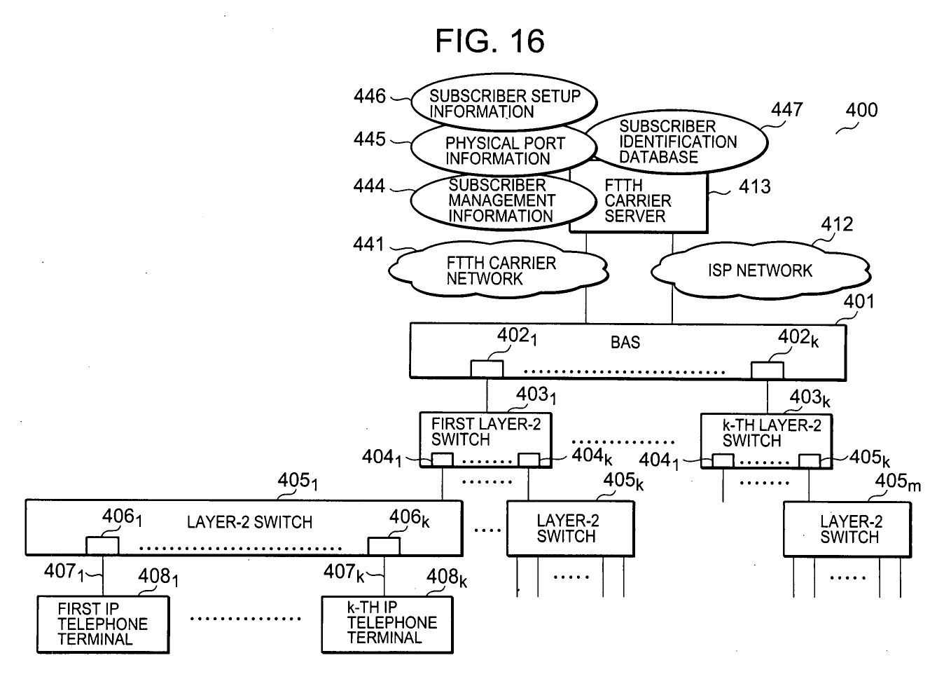

FIG. 16 depicts a configuration of a network connection system according to a second example of the present invention. In this network connection system 400, a method for identifying a subscriber is devised specially in the case where FTTH (Fiber To The Home) or the like causes a subscriber line termination device to be provided separately from a modem (not shown) and a media converter (not shown).

In the network connection system 400, a plurality of layer-2 switches 403₁-403ₖ and 405₁-405ₘ are hierarchically connected to form a connection network through which each of IP telephone terminals are connectable to a broadband access server (BAS) 401. The 1st to k-th layer-2 switches 403₁ to 403ₖ on a first layer can be connected to 1st to k-th accommodation ports 402₁ to 402ₖ of a broadband access server (BAS) installed in the premises of a communication station (not shown) to provide broadband continuous connection services. Each of the 1st to k-th layer-2 switches 403₁ to 403ₖ on the first layer is equipped with 1st to k-th physical ports 404₁ to 404ₖ, each of which is connected to a corresponding one of the 1st to m-th layer-2 switches 405₁ to 405ₘ on a second layer. Here, the maximum value of m is equal to k×k. Each of the 1st to m-th layer-2 switches 405₁ to 405ₘ on the second layer is also equipped with 1st to k-th physical ports 406₁ to 406ₖ, to which IP telephone terminals 408₁ to 408ₖ are connected through access lines 407₁ to 407ₖ, respectively. A FTTH carrier server 413 is connected to the uplink side of the BAS 401 through a FTTH carrier network 411 and an ISP network 412.

Similarly to the ADSL carrier server 208 in the first example (see FIG. 9), the FTTH carrier server 413 is provided with line carrier subscriber management information 444, physical port information 445, subscriber setup information 446, and a subscriber identification database 447. Moreover, each of the IP telephone terminals 408₁ to 408ₖ is provided with circuitry (not shown) similar to that of the ADSL modem 204 shown in FIG. 7 in the first example. Further, the BAS 401 is provided with circuitry (not shown) similar to that of the ADSL line facility 202 shown in FIG. 8 in the first example. It should be noted, however, that the IP telephone terminals 408₁ to 408ₖ do not need to include modulation/demodulation means for allowing connection to the access lines 407₁ to 407₅.

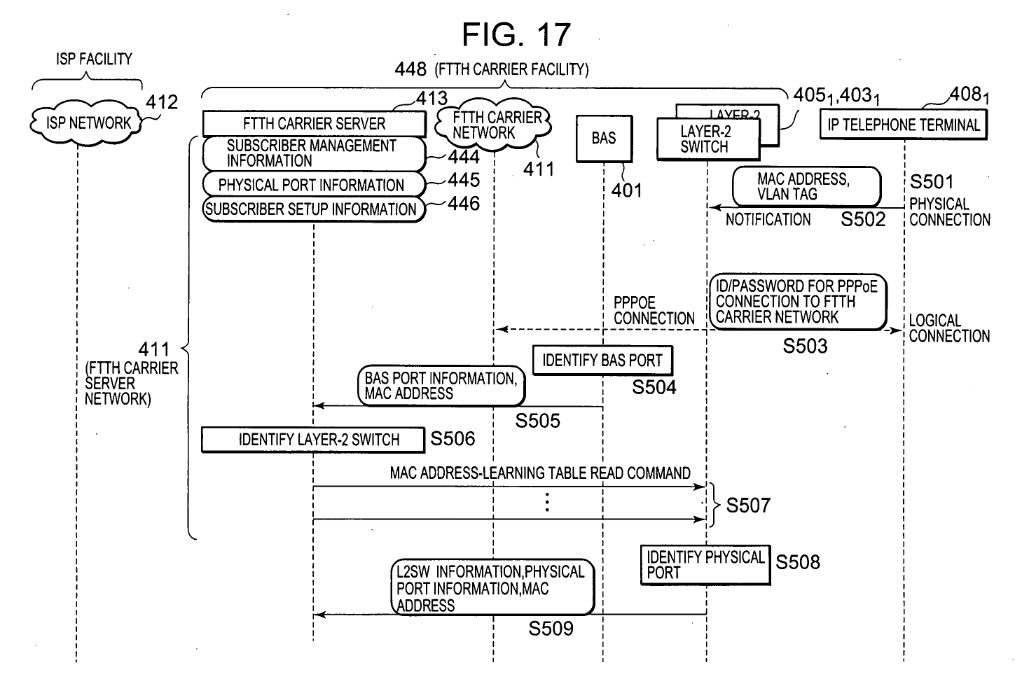

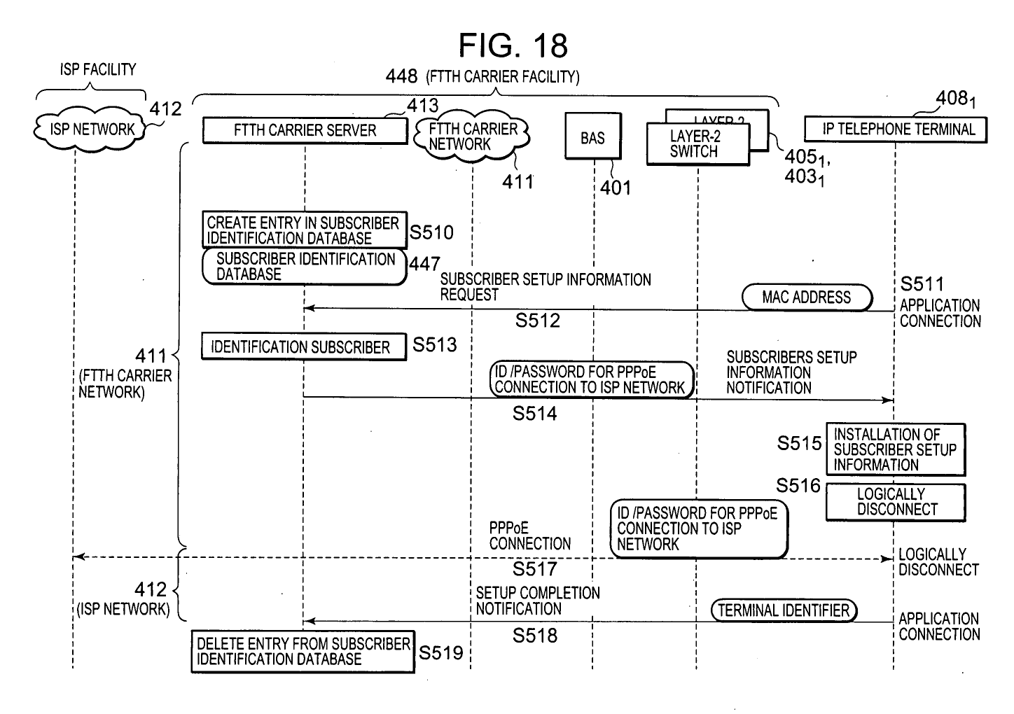

FIGS. 17 and 18 show the first and second halves, respectively, of the entire flow of a method for specifying a subscriber in the network connection system according to the second example. In the second example, a description will be given on the assumption that the first IP telephone terminal 408₁ shown in FIG. 16 makes a communication service setup request. Incidentally, in FIGS. 17 and 18, a FTTH carrier facility 448 includes the layer-2 switches 403 and 405, BAS 401, FTTH carrier network 411, and FTTH carrier server 413.

It is assumed that at the subscriber's premises (not shown), the first IP telephone terminal 408₁ is physically connected to the first layer-2 switch 405₁ on the second layer only when a setup request is made. When a physical connection is made (step S501 in FIG. 17), the first IP telephone terminal 408₁, with its unique MAC address, is logically connected to the first layer-2 switch 405₁ on the second layer by using a VLAN (Virtual Local Area Network) tag, which is given only when a setup request is made. Thus, a communication service setup request is notified (step S502).

The first IP telephone terminal 408₁ is logically connected further to the FTTH carrier network 411 by using a PPPoE ID and password, thereby acquiring an IP address of its own (step S503). Here, the PPPOE ID and password are set onto the first IP telephone terminal 408₁ in advance, as data for use in making a setup request, when the first IP telephone terminal 408₁ is shipped out from a factory. Based on this logical connection, the BAS 401 identifies the accommodation port (BAS port) 402₁ (step S504). The BAS 401 then notifies the FTTH carrier server 413 of the MAC address of the first IP telephone terminal 408₁ and the BAS port 402₁ accessed by the first IP telephone terminal 408₁ (step S505) With this notification, the FTTH carrier server 413 identifies a layer-2 switch involved in the IP telephone terminal 408₁ (step S506).

Next, to manage a structure of the network, the FTTH carrier server 413 issues a MAC address learning table read command to each of a plurality of those layer-2 switches 403 and 405 connected to the ports of the BAS 401 (step S507). With this command, it is determined which physical ports of which layer-2 switches have learnt the MAC address in question, and the physical ports of the layer-2 switches 403 and 405 in question are identified (step S508). Then, the physical port information indicating the identified physical ports, the MAC address as the terminal identifier, and the layer-2 switch (L2SW) information regarding the layer-2 switches in question are notified to the FTTH carrier server 413 (step S509)

Upon the receipt of the notification of step S509, the FTTH carrier server 413 creates a corresponding entry in the subscriber identification database 447, which is composed of the MAC address and the subscriber setup information 446, through the processing as described in FIG. 12 (step S510 in FIG. 18).

In this subscriber identification database 447, similarly to the subscriber identification database 247 in the first example as described in FIG. 13, the physical port information 445 and the MAD address are registered (see step S361). At the same time, a timer is started (see step S362), and it is monitored whether or not a period of time set on the timer has expired (see step S363). If a request for the subscriber setup information, by means of an application connection (step S511), arrives from the first IP telephone terminal 408, before the period of time set on the timer has expired (step S512; see Y at step S364), then the subscriber is identified (step S513) and the subscriber setup information 446 for the subscriber in question is notified to the first IP telephone terminal 408₁ (step S514).

When the subscriber setup information 446 is notified, the first IP telephone terminal 408₁ performs installation of this subscriber setup information 446 (step S515). Thereafter, the first IP telephone terminal 408₁ is logically disconnected from the FTTH carrier server 413 (step S516) and is connected instead to the ISP network 412 (step S517). In this event, the first IP telephone terminal 408₁ uses an ID and a password for PPPOE connection, to be PPPoE-connected (logically connected) to the ISP network 412. Then, the first IP telephone terminal 408₁ sends a setup completion notification to the FTTH carrier server 413, as an application connection (step S518). Upon this notification, the FTTH carrier server 413 deletes the corresponding entry from the subscriber identification database 447 by using the MAC address as a key, which has been sent from the first IP telephone terminal 408₁ as the terminal identifier along with the notification (step S519).

As described above, according to the second example, a VLAN tag is used as the first-time flag. Therefore, when a search of the MAC address-learning table is performed, it is sufficient to search only for the MAC address connected to the VLAN network to which an IP telephone terminal such as the first IP telephone terminal 408₁ gains access only for the first time. Accordingly, there is an advantage that the efficiency of search is increased.

Moreover, even if an illegitimate party attempts to access the FTTH carrier server 413 with a fake terminal identifier of an IP telephone terminal, it is quite difficult to gain access in the disguise of a legitimate user unless the IP telephone terminal belongs to the VLAN network, to which IP telephone terminals gain access only for the first time. Accordingly, there is an advantage that it is possible to effectively prevent unauthorized accesses.

It should be noted that although the BAS 401 is used in the second example, the server is not limited to this type. For example, it is also possible to configure a network connection system of the present invention by using another type of server such as a DHCP server and by assigning an IP address.

Moreover, although the ADSL modems 204 and the IP telephone terminals 408 have been described as examples of a network device in the above specific examples, the network device is not limited to these types. The present invention, as a matter of course, can apply to a variety of network devices as long as a network device is physically connected to a connection device and thereby gains access to a communication network by using subscriber setup information. It is needless to say that various well-known technologies are applicable to the determination as to whether or not a physical connection of a network device is the first one.

Furthermore, the carrier network is not limited to the ADSL carrier network or FTTH carrier network. Examples of the carrier network also include a CATV (Community Antenna Television; Cable Television) carrier network, for example.

1. A network device which is connectable to a communication network by subscriber setup information, comprising:
a subscriber setup information determining section for determining whether the subscriber setup information has been installed;
a subscriber setup information request section for transmitting a request for the subscriber setup information to the network device manager through a connection device when the subscriber setup information has not been installed; and
a memory section for storing the subscriber setup information received from the network device manager so that the network device is connectable to the communication network.

2. The network device according to claim 1, wherein the subscriber setup information determining section checks whether the memory stores the subscriber setup information, wherein, when the memory does not store any subscriber setup information, it is determined that the network device makes a first-time connection to the communication network.

3. The network device according to claim 1, further comprising:
a subscriber setup information setting section for setting the subscriber setup information received from the network device manager.

4. The network device according to claim 1, further comprising:
a connection control section controlling such that a connection to the network device manager is logically disconnected after the subscriber setup information has been set up and thereafter a connection to the communication network is logically set up using the subscriber setup information.

5. The network device according to claim 1, wherein the connection device has at least one physical port to which the network device is physically connectable by an access line.

6. The network device according to claim 5 having a subscriber line termination function.

7. The network device according to claim 1, wherein the connection device is connected to the communication network and a line carrier network which is connected to the network device manager.

8. The network device according to claim 7, wherein the communication network is the Internet and the line carrier network is an ADSL (Asymmetric Digital Subscriber Line) carrier network.

9. The network device according to claim 7, wherein the communication network is the Internet and the line carrier network includes a FTTH (Fiber To The Home) carrier network.

10. The network device according to claim 7, wherein the network device manager is a carrier server connected to the line carrier network and the Internet.

11. A network device manager for managing a network device which is connectable to a communication network through a connection device which is connectable to both the communication network and a line carrier network, comprising:
a first-time connection determining section for determining, based on information received from the connection device through the line carrier network, whether the network device is physically connected to the connection device for the first time;
a subscriber setup information generating section for generating the subscriber setup information for the network device when it is determined that the network device is physically connected to the connection device for the first time; and
a subscriber setup information transmitting section for transmitting the subscriber setup information to the network device.

12. The network device manager according to claim 11, further comprising:
a memory for storing the subscriber setup information for the network device; and
a subscriber setup information controller controlling such that, when having received a setup completion notification of the subscriber setup information from the network device, the subscriber setup information for the network device is deleted from the memory.

13. The network device manager according to claim 11, further comprising:
a timer for measuring an elapsed time from when it is determined that the network device is physically connected to the connection device for the first time;
a monitor for monitoring reception of a subscriber setup information request from the network device; and
a notifying section for notifying the network device of abnormality when the monitor detects no reception of the subscriber setup information request within a predetermined time period measured by the timer.

14. The network device manager according to claim 11, further comprising:
a timer for measuring an elapsed time from when it is determined that the network device is physically connected to the connection device for the first time; and
a monitor for monitoring reception of a subscriber setup information request from the network device, wherein when the monitor detects no reception of the subscriber setup information request within a predetermined time period measured by the timer, the subscriber setup information controller deletes the subscriber setup information for the network device from the memory.

15. The network device manager according to claim 14, wherein the monitor also monitors a setup completion notification of the subscriber setup information from the network device, wherein the subscriber setup information controller deletes the subscriber setup information for the network device from the memory when the monitor detects no reception of the setup completion notification within the predetermined time period measured by the timer.

16. The network device manager according to claim 11, wherein the communication network is the Internet and the line carrier network is one of an ADSL (Asymmetric Digital Subscriber Line) carrier network and a FTTH (Fiber To The Home) carrier network.

17. A method for connecting a network device to a communication network through a connection device which is connectable to both the communication network and a line carrier network, comprising:
determining whether the network device is physically connected to the connection device for the first time;
transmitting a request for subscriber setup information to a network device manager through the connection device and the line carrier network when it is determined that the network device is physically connected to the connection device for the first time, wherein the subscriber setup information is needed for the network device to connect to the communication network;
when receiving the subscriber setup information from the network device manager, installing it on the network device; and
connecting the network device to the communication network using the subscriber setup information.

18. The method according to claim 17, wherein when the network device has not been installed with the subscriber setup information, it is determined that the network device is physically connected to the connection device for the first time.

19. The method according to claim 17, wherein a logical connection to the network device manager is disconnected after the subscriber setup information has been installed and thereafter a logical connection to the communication network is set up using the subscriber setup information.

20. A method for managing a network device which is connectable to a communication network through a connection device which is connectable to both the communication network and a line carrier network, comprising:
determining, based on information received from the connection device through the line carrier network, whether the network device is physically connected to the connection device for the first time;
generating the subscriber setup information for the network device when it is determined that the network device is physically connected to the connection device for the first time; and
transmitting the subscriber setup information to the network device.

21. The method according to claim 20, further comprising:
storing the subscriber setup information for the network device in a memory; and
when having received a setup completion notification of the subscriber setup information from the network device, deleting the subscriber setup information for the network device from the memory.

22. The method according to claim 20, further comprising:
measuring an elapsed time from when it is determined that the network device is physically connected to the connection device for the first time;
monitoring reception of a subscriber setup information request from the network device; and
notifying the network device of abnormality when a predetermined time period has elapsed without reception of the subscriber setup information request.

23. The method according to claim 20, further comprising:
measuring an elapsed time from when it is determined that the network device is physically connected to the connection device for the first time; and
monitoring reception of a subscriber setup information request from the network device, when a predetermined time period has elapsed without reception of the subscriber setup information request, deleting the subscriber setup information for the network device from the memory.

24. The method according to claim 23, further comprising:
monitoring reception of a setup completion notification of the subscriber setup information from the network device; and
deleting the subscriber setup information for the network device from the memory when a predetermined time period has elapsed without reception of the subscriber setup information request.

25. A line carrier facility for managing a plurality of network devices to connect to a communication network, comprising:
a connection section for connecting a network device to each of the communication network and a line carrier network; and
a management server for managing each the plurality of network devices, wherein the connection section comprises:
a detector for detecting first-time connection information received from a network device; and
a communication section for notifying the management server of first-time connection occurrence when the first-time connection information has been received from the network device, and the management server comprises:
a storage section for storing subscriber setup information for the network device when it is notified that the network device makes a first-time connection; and
a setup section for transmitting the subscriber setup information to the network device in response to reception of a subscriber setup information from the network device.

26. The line carrier facility according to claim 25, wherein the connection section is a connection device having a plurality of physical ports each connectable to a plurality of network devices.

27. The line carrier facility according to claim 25, wherein the connection section comprises a hierarchal structure of switch devices and a server connecting a top layer of switch devices to each of the communication network and a line carrier network, wherein a bottom layer of switch devices are physically connected to the plurality of network devices.

28. A program instructing a computer of a network device to connect the network device to a communication network through a connection device which is connectable to both the communication network and a line carrier network, the program comprising:
determining whether the network device is physically connected to the connection device for the first time;
transmitting a request for subscriber setup information to a network device manager through the connection device and the line carrier network when it is determined that the network device is physically connected to the connection device for the first time, wherein the subscriber setup information is needed for the network device to connect to the communication network;
when receiving the subscriber setup information from the network device manager, installing it on the network device; and
connecting the network device to the communication network using the subscriber setup information.

29. A program instructing a computer of a network device manager to manage a network device which is connectable to a communication network through a connection device which is connectable to both the communication network and a line carrier network, the program comprising:
determining, based on information received from the connection device through the line carrier network, whether the network device is physically connected to the connection device for the first time;
generating the subscriber setup information for the network device when it is determined that the network device is physically connected to the connection device for the first time; and
transmitting the subscriber setup information to the network device.

30. A connection device for connecting a network device to a communication network and a line carrier network, comprising:
a first-time connection determining section for determining, based on information received from the connection device through the line carrier network, whether the network device is physically connected to the connection device for the first time;
a network device notifying section for notifying a network device manager of identification information for identifying the network device and its location; and
a transfer section for transferring data and signals from the network device to one of the network device manager and the communication network, and vice versa.

31. A connection network for connecting a network device to a communication network and a line carrier network, comprising:
an access server which connects a plurality of ports to the communication network and the line carrier network; and
a plurality of switches which are hierarchically connected and through which a network device is connectable to the access server, wherein the access server comprises:
a first-time connection determining section for determining, based on information received from the network device, whether the network device is physically connected to the connection device for the first time;
a network device notifying section for notifying a network device manager of identification information for identifying the network device and its location; and
a transfer section for transferring data and signals from the network device to one of the network device manager and the communication network, and vice versa.

32. A network device which is connectable to a communication network by subscriber setup information, comprising:
subscriber setup information determining means for determining whether the subscriber setup information has been installed;
subscriber setup information request means for transmitting a request for the subscriber setup information to the network device manager through a connection device when the subscriber setup information has not been installed; and
memory means for storing the subscriber setup information received from the network device manager so that the network device is connectable to the communication network.

33. A network device manager for managing a network device which is connectable to a communication network through a connection device which is connectable to both the communication network and a line carrier network, comprising:
first-time connection determining means for determining, based on information received from the connection device through the line carrier network, whether the network device is physically connected to the connection device for the first time;
subscriber setup information generating means for generating the subscriber setup information for the network device when it is determined that the network device is physically connected to the connection device for the first time; and
subscriber setup information transmitting means for transmitting the subscriber setup information to the network device.
